(19) United States
(12) Patent Application Publication
(10) Pub. No.: US 2023/0385874 A1
(43) Pub. Date: Nov. 30, 2023

(54) OPTIMIZING TRIAL RESOURCE ALLOCATIONS TO PROMOTE PRODUCT ACQUISITION

(71) Applicant: Microsoft Technology Licensing, LLC, Redmond, WA (US)

(72) Inventor: Brijesh Bharadwaj, Redmond, WA (US)

(73) Assignee: Microsoft Technology Licensing, LLC, Redmond, WA (US)

(21) Appl. No.: 17/804,845

(22) Filed: May 31, 2022

(51) Int. Cl. G06Q 30/02

(52) U.S. Cl. CPC G06Q 30/0249

(57) ABSTRACT

The present disclosure relates to a system for optimizing a trial of software product within a budget. In particular, the disclosed technology estimates a resource value of product acquisition for a product and determines a trial budget for the product. A software provider offers the first trial of the product to the user for a first trial period based on the trial budget and a resource cost associated with providing the product and collects data associated with the first trial of the product. In response to the first trial not resulting in the product acquisition, a subsequent trial optimizer uses a model for evaluating the collected data and determines a parameter for optimizing a second trial of the product for the user within a remaining trial budget. Based on the at least one parameter, the system offers the second trial of the product to the user.

### BACKGROUND

Cloud-based software products and services are widely provided to both consumers (end users) and enterprises (or tenants). Cloud computing environments involve a distributed set of resources, including memory, processing units, and data storage communicatively coupled via a secured network. This type of distributed infrastructure enables software providers to dynamically allocate resources for deploying and testing new and updated software. Large-scale software-as-a-service (SaaS) providers (hereinafter “software providers”) continuously deploy features to a worldwide customer base. Often, when releasing a new product or feature, software providers offer potential consumers a trial period for accessing and evaluating the product or feature. Since providing the product during the trial period requires an expenditure of resources, software providers limit the trial period based on a trial budget per user. While some potential consumers take advantage of the limited trial period, others may activate the trial but fail to fully engage with the new product or feature. For instance, during the limited trial period, some consumers may have insufficient time to test the product, may have a poor user experience (e.g., high latency due to network instability during that time), may overlook the new features as part of a larger product offering, or the like. Since product trials are generally offered only once, it is difficult for software providers to determine why one consumer acquired the new product whereas another consumer did not. That is, there may be many reasons other than dissatisfaction with the new product that cause a consumer not to acquire the product.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relates to a system for optimizing a trial of software product within a budget. The present disclosure relates to estimating a resource value of product acquisition for a product. Based on the estimated resource value, the disclosed technology determines a trial budget for the product. Based on the trial budget and a resource cost of providing the product, a first trial period for a first trial of the product may be determined. The system offers the first trial of the product to the user for the first trial period. The system collects data associated with the first trial of the product. In response to the first trial not resulting in the product acquisition, the software provider determines a remaining trial budget based on the resource cost and the collected data. Based on evaluating the collected data using a model, a subsequent trial optimizer determines at least one parameter for optimizing a second trial of the product for the user within the remaining trial budget. Based on the at least one parameter, the system offers the second trial of the product to the user. In the present disclosure, the resource cost of providing the product is based on a usage time or a usage amount. The resource cost of providing the product is determined on a per-user basis over time. The collected data includes one or more of: telemetry data, usage time, usage amount, usage consistency, user satisfaction data, or a user experience (UX) level. The UX level during the first trial is based on one or more of: product instability, network latency, processing latency, user-reported issues, helpline usage, or complaints. The model is one of a rule-based model or a machine learning (ML) model. Optimizing the second trial of the product for the user is automated. Optimizing the second trial of the product for the user includes selecting the at least one parameter with the highest likelihood of resulting in product acquisition. The at least one parameter comprises one or more of: a second trial period, a second trial amount of uses, a portion of the day, a subset of the product, a setup experience, or a support experience.

The present disclosure further relates to a method of generating a model to optimize a product trial for a user. The method includes collecting data associated with a plurality of product trials; identifying patterns in the collected data; based on the patterns, mapping one or more metrics to a product acquisition; determining one or more trial parameters for promoting metrics mapped to the product acquisition; and generating a model for automatically optimizing a product trial for a user. The model is designed to be optimized the product trial for the user by automatically selecting at least one trial parameter having the highest likelihood of product acquisition by the user within a trial budget for the product. The model is a rule-based model.

The present disclosure further relates to a method of optimizing a product trial for a user within a trial budget. The method comprises estimating a resource value of product acquisition for a product; based on the estimated resource value, determining the trial budget for the product; based on the trial budget and a resource cost of providing the product. A first trial period for a first trial of the product is determined. The software provider offers the first trial of the product to the user for the first trial period and collects data associated with the first trial of the product. In response to the first trial not resulting in the product acquisition, the method determines a remaining trial budget based on the resource cost and the collected data. Based on evaluating the collected data using a model, the method determines at least one parameter for optimizing a second trial of the product for the user within the remaining trial budget. Based on the at least one parameter, the method includes offering the second trial of the product to the user.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an example system for optimizing a trial of a software product within a budget, in accordance with aspects of the present disclosure.

FIG. 2 illustrates an example block diagram for collecting data during a trial period of a software product, in accordance with aspects of the present disclosure.

FIG. 3 illustrates an example block diagram for evaluating data collected during a trial period to identify patterns, in accordance with aspects of the present disclosure.

FIGS. 4A-4B illustrate an example method for optimizing a trial of a software product within a budget, in accordance with aspects of the present disclosure.

FIG. 5 illustrates an example method for determining rules or training a machine-learning (ML) model based on patterns in collected data, in accordance with aspects of the present disclosure.

FIG. 6 is a block diagram illustrating example physical components of a computing device with which aspects of the present disclosure may be practiced.

FIG. 7A is a simplified diagram of a mobile computing device with which aspects of the present disclosure may be practiced.

FIG. 7B is another simplified block diagram of a mobile computing device with which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

As detailed above, software providers often offer potential consumers a trial period for accessing and evaluating a new product or feature. Since providing the product during the trial period requires an expenditure of resources, software providers limit the trial period based on a trial budget per user. While some potential consumers take advantage of the limited trial period, others may activate the trial but fail to fully engage with the new product or feature. For instance, during the limited trial period, some consumers may have insufficient time to test the product, may have a poor user experience (e.g., high latency due to network instability during that time), may overlook the new features as part of a larger product offering, or the like. Since product trials are generally offered only once, it is difficult for software providers to determine why one consumer acquired the new product whereas another consumer did not. That is, there may be many reasons other than dissatisfaction with the new product that cause a consumer not to acquire the product.

According to the present disclosure, the above and other issues are resolved by optimizing a subsequent product trial for a user based on heuristics developed using available data collected during initial product trial(s), such as telemetry, usage, satisfaction, or other user generated data. In aspects, the term “software product” or “product” may refer to a single product, a suite of products, a tier within a product or suite, a value added service, or a feature or features of a product. Data collected from initial product trials may include the particular user and/or a population of users. For instance, evaluating data from a population of users enables patterns to be identified that can be mapped to a likelihood (or potential) of product acquisition by the user. For instance, it may be determined that users who consistently engage with a product throughout a trial period acquire the product 83% of the time. Alternatively, it may be determined that users who only engage with the product for the first few days of a trial rarely (e.g., 23%) acquire the product. Based on the heuristics, subsequent product trials can be optimized to offer one or more of the following: an extended trial period of the original offering, a partial trial of some subset of the product, a support experience, or the like. In aspects, the subsequent product trials may be offered to users with a remaining trial budget (based on actual usage) such that software providers may not incur unbudgeted costs for the subsequent trials.

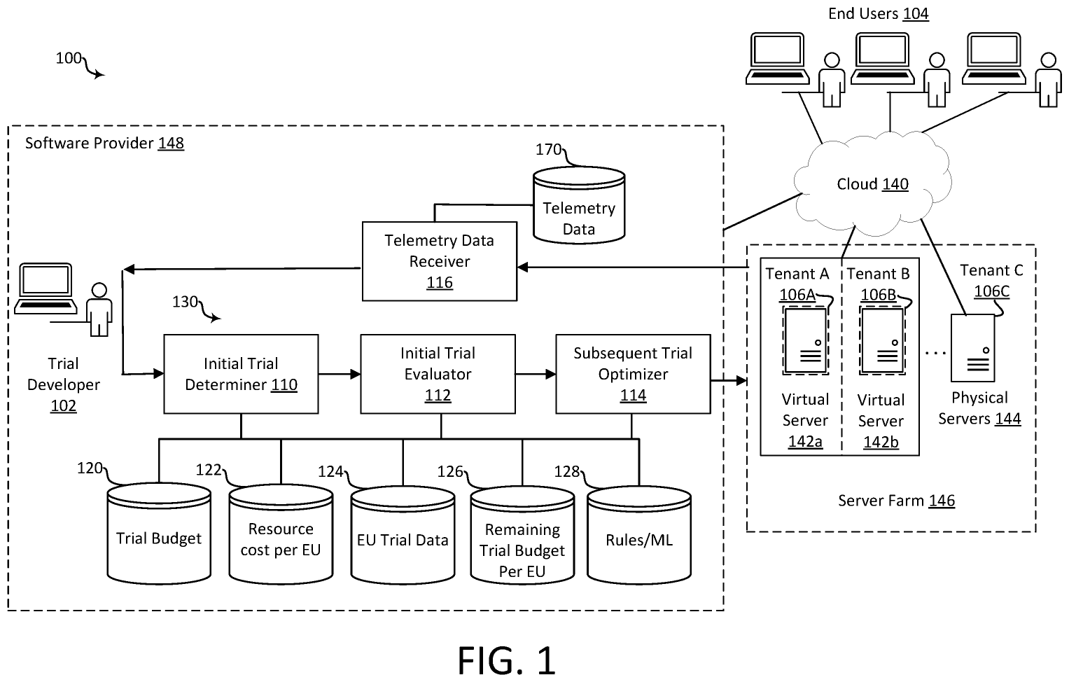

FIG. 1 illustrates an example system 100 for optimizing a trial of a software product within a budget, in accordance with aspects of the present disclosure.

Trial developer 102 may oversee development of trials for different products and features. In aspects described herein, an automated system 130 may be developed to optimize product trials. The automated system 130 may include an initial trial determiner 110, an initial trial evaluator 112, and a subsequent trial optimizer 114. The initial trial determiner 110 may determine an initial product trial based on a trial budget 120, resource costs per end user 122, and end user trial data 124. In aspects, the trial budget 120 may be determined based on a resource value of product acquisition. The resource value may be based on any number of metrics. For instance, the resource value may be an amount of revenue received from selling (or licensing) the product less an amount of resource cost incurred in developing, testing, maintaining, and supporting the product, for instance. In addition to software development costs, a software provider may incur resources costs for hosting the product, including energy resources, processing resources, network resources, memory and storage resources, real estate, labor resources, and the like. In aspects, these resource costs may be aggregated for a time period (e.g., 1 minute, 1 hour, 1 day, 1 month, 1 year, or any multiple or combination thereof). The resource costs per end user 122 may then be determined by, for example, taking the aggregated resource costs for the time period divided by the average number of end users 104 utilizing the product during the same period.

Based on the resource value, the trial budget 120 for testing the product may be determined. For instance, the trial budget 120 may be some portion or percentage of the resource value that the provider is willing to incur to promote the product. For instance, the trial budget may be 5%, 10%, 25%, or other percentage, of the resource value of the product. In other examples, the trial budget 120 may be equal to or greater than the resource value. For instance, the product may be offered as a free upgrade to all or a subset of current customers to generate sustained usage and a critical mass of users. As an example, an interactive online subscription (e.g., to an online gaming suite) requires a critical mass of subscribers in order to support multi-player functionality. To promote growth, free subscriptions to current customers may be absorbed (e.g., written off) as the cost of acquiring a completely new user base of customers. That is, to focus on acquisition, the software provider may allow for loss leaders (e.g., for which trial costs are greater than resource value), particularly where product success is driven by a critical mass of users.

As should be appreciated, the trial budget 120 may be subsequently revised for any of a number of reasons, e.g., fluctuations in resource costs, fluctuations in resource value, provider marketing focus (e.g., increasing or decreasing amount/percentage of trial spend), mis-matched trials (e.g., customer selected a product for the initial trial that was unsuited to customer needs), changes in product features which support reevaluation of previous trial users (even if the initial trial budget was exceeded), inflation, changes in provider profit/revenue models, or the like.

Based on the trial budget 120 and the end user resource costs 122 over time, the initial trial determiner 110 may determine an initial trial period. The first trial period is an amount of time an end user 104 can test the product within the trial budget 120 based on the end user resource costs 122. For example, if the end user resource costs are $5.00 per day, and the trial budget is $50.00, the first trial period for the end user 104 may be 10 days.

In some examples, end users 104 may use computing devices to access software products and services offered by software provider 148 via cloud computing environment 140. For instance, an end user 104 may test a new product during an initial product trial via the cloud computing environment 140. The end user 104 may be associated with a tenant (e.g., tenant A 106a, tenant B 106b, or tenant C 106c) hosted by the software provider 148 on cloud computing environment 140. The cloud computing environment 140 may comprise a cloud of servers that are inter-connected, e.g., including the server farm 146, to collectively provide products (e.g., the new product) to end users 104. A server farm 146 may contain virtual servers 142a/b and physical servers 144. The virtual servers 142a/b may be partitioned on one or more physical servers 144 may provide functionality (e.g., processing and memory) of a dedicated server to one or more tenants. Tenant A 106A may use one virtual server 142a and tenant B 106B may use another virtual server 142b in a set of virtual servers 142a/b, for example.

Memory in the respective virtual servers 142a/b and physical servers 144 may store program instructions for execution by Central Processing Unit (CPU), not shown in the figure. Execution of the program instructions makes products (e.g., a new product) available for use by end users 104. In aspects, the server farm 146 and the cloud computing environment 140 comprise resources of the software service provider 148. In aspects, these resources are associated with a resource cost to the software provider 148 for providing the new product during the initial trial, which may be quantified as end user resource costs 122. In aspects, there may be millions of end users 104 using various products made available for an initial trial by the software provider 148.

In other examples, end users 104 may access software products and services offered by software provider 148 via private networks or delivered directly to an end user device. For example, software provider 148 may provide product trials directly to end user devices, on-premises (“on-prem”) devices at a network edge, or the like. While many of the examples described herein are from a cloud-based perspective, the disclosure is not so limited. That is, the analyses described herein may be conducted by software running on any computing device capable of receiving monitored user data and performing trial-optimization calculations either now or in the future. Such computing devices may include, for example, end user mobile devices, laptops, personal computing devices, provider-hosted cloud computing (including intermediate devices such as gateways, firewalls, proxy computers, etc.). Moreover, the software may be run in a distributed manner, with monitoring, storage, processing, computation, etc., being performed across multiple devices owned by the same or different entities, including distributed devices of a cloud network (e.g., near-edge, far-edge, network core, and/or datacenter nodes), devices owned by internet service providers (ISPs), devices owned by partners of the software provider, devices owned by enterprise customers (e.g., on-prem devices in a private network or a server farm hosted by the enterprise), and devices owned by end users, and the like.

In examples, the resources of the software provider 148 may monitor various metrics during initial product trials regarding the computing devices of end users 104, the server farm 146, the cloud computing environment 140, or the like, to obtain the end user trial data 124 and/or the telemetry data 170. For instance, the monitoring may log usage data, telemetry data, and/or satisfaction data. Usage data may include usage time, usage distribution (e.g., during the beginning of the trial, during the end, consistently throughout, etc.), usage time of day (e.g., daytime, nighttime, etc.), percentage of features used (e.g., 34% of product's features), duration per use (e.g., average of 2:34 hours per use), etc. Satisfaction data may result from user interactions with the software provider, such as complaints, survey results, support calls, product acquisition, or the like. In addition to data collected during the first product trial, the software provider may have collected historical user data or preferences from the particular end user 104 or a population of end users 104, such as preferred game genre (e.g., action, shooter, race, puzzle, adventure, simulation, etc.), productivity software package (e.g., commercial enterprise level, personal basic or pro package, etc.), reserved data storage (e.g., personal cloud services, enterprise cloud services), user longevity (e.g., 0-5 years, 5-10 years, etc.), or the like.

In some aspects, telemetry data from the initial trial may be included with end user trial data 124. In other aspects, telemetry data 170 may be collected by telemetry data receiver 116 during an initial trial and stored separately. For instance, telemetry data receiver 116 receives status information from servers in the server farm 146. The status information measures or describes how end users 104 of tenants 106A-B interact with features of products (e.g., the new product). For instance, the telemetry data 170 may include logs related to how end users 104 access the product (e.g., click data, input queries and output results, success reports or error reports, etc.). Additionally or alternatively, the telemetry data 170 may include error logs or exceptions associated with executing the program instructions for a product. In aspects, the automated system 130 may receive telemetry data 170 for analyzing performance and/or stability of the new product, user and/or software provider systems, the network of the cloud computing environment 140 and/or the end user 104, or the like.

Initial trial evaluator 112, may analyze the end user trial data 124 and/or the telemetry data 170 to evaluate the initial product trial. For instance, initial trial evaluator 112 may determine whether the end user 104 acquired the product in response to the first product trial. If the end user 104 did not acquire the product, initial trial evaluator 112 may determine whether there is a remaining trial budget 126 for the end user 104. As noted above, the trial budget 120 may be some portion or percentage of the resource value that the provider is willing to incur to promote the product. Based usage data retrieved from the end user trial data 124, and the end user resource costs 122, the initial trial evaluator 112 may determine an actual resource cost for the user's actual usage during the first product trial. For instance, using the example above, if the end user resource costs 122 are $5.00 per day and the actual usage during the first product trial was 4.3 days, the actual resource cost of the user's actual usage would be $21.50. Again, based on the above trial budget of $50.00, the remaining trial budget 126 would be $28.50.

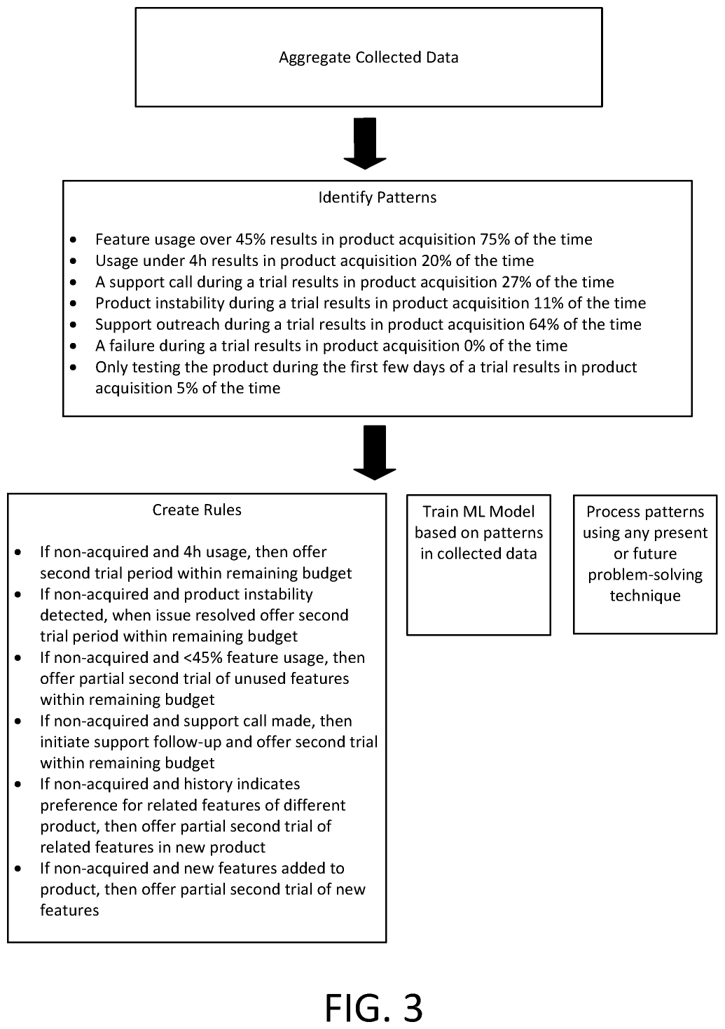

In aspects, subsequent trial optimizer 114 may analyze the end user trial data 124 and/or the telemetry data 170 based on a model 128. In aspects, the model 128 may be a rule-based model, a machine learning (ML) model, or any other suitable model for evaluating data. For instance, as described with respect to FIG. 3, the model 128 may be created based on evaluating data from a population of end users 104 who have engaged in product trials. Patterns may be identified in the data which can be used to generate rules and/or train a ML model. For example, a pattern may indicate that when usage time is above some amount (e.g., 15 hours), the end user 104 acquires the product some percentage (e.g., 83%) of the time. That is, usage time may be mapped to product acquisition. In this case, a rule may indicate that, if the end user 104 did not acquire the product and usage was less than 15 hours, then more trial time may result in product acquisition. Alternatively, a pattern may indicate that when an end user 104 only tests the product during the first few days of a trial, the end user 104 acquires the product only 5% of the time. In this case, a usage distribution (e.g., during the first few days only) may be mapped to product acquisition. A corresponding rule may indicate that, if the end user 104 only used the product during the first few days of a trial and did not acquire the product, then a subsequent trial may not result in product acquisition.

In response to evaluating the end user trial data 124 and/or the telemetry data 170 based on the model 128 and the remaining trial budget 126, the subsequent trial optimizer 114 may determine one or more trial parameters that promote metrics mapped to product acquisition. The one or more trial parameters may include, for instance, a subsequent trial period, a subsequent trial amount of uses, a portion of the day, a subset of the product, a setup experience, or a support experience. In an example, if feature usage is mapped to product acquisition, an increased feature usage may increase a likelihood of product acquisition. In this case, a corresponding trial parameter may indicate a subset of the product (e.g., unused features) to offer in the subsequent trial. The targeted offering of unused features may increase overall feature usage, which may increase a likelihood of product acquisition.

In other cases, the trial parameters may be determined based on collected data specific to the end user 104. As an example, if the end user 104 only tested the product in the evenings during the initial trial, a corresponding trial parameter may specify a time of day for offering the subsequent trial (e.g., between 5:00 PM and midnight). In this case, making the product available during a preferred portion of the day may increase overall usage, which may increase a likelihood of product acquisition. As should be appreciated, rules may be limited such that the subsequent trial does not exceed the remaining trial budget 126. That is, for a remaining trial budget 126 of $28.50 and end user resource costs 122 of $5.00 per day (or $0.21 per hour), the end user 104 may be offered a subsequent trial with a subsequent trial period of 5.7 days (e.g., rounded to 6 days). However, if the subsequent trial is only offered from 5:00 PM to midnight (e.g., 7 hours per day) based on a user preference for nighttime use, the subsequent trial period may be 135.7 hours, or 19.4 days (e.g., rounded to 19 days) from 5:00 PM to midnight. In this way, the subsequent trial is offered during a preferred time of day for a longer period, which may further increase overall usage and the likelihood of product acquisition.

Moreover, the subsequent trial optimizer 114 may automatically select at least one of the one or more parameters to optimize the subsequent trial for the end user 104. As detailed above, the one or more parameters may result from various rules or training applied to the end user trial data 124. However, some parameters may be more likely to result in product acquisition within the remaining trial budget than others. For instance, based on evaluating the end user trial data 124 with the model 128, subsequent trial optimizer 114 may determine that offering a subset of unused features for a shorter trial period may be more likely to result in product acquisition than offering the full product for a longer trial period. In this case, the model may automatically select the at least one parameter directed to the subset of unused features to optimize the subsequent trial for the end user 104. That is, the model 128 may automatically select the at least one parameter that is most likely to result in product acquisition by this particular end user 104. In this way, the subsequent trial is not only optimized for product acquisition, the optimization is customized for the particular end user 104.

As should be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

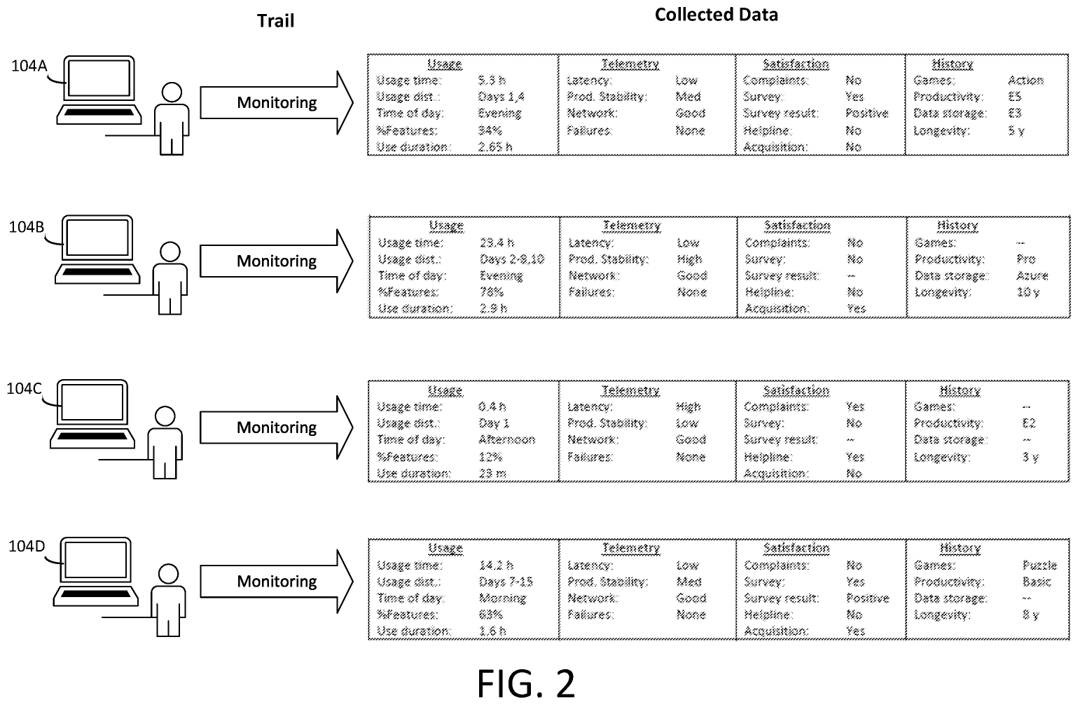

FIG. 2 illustrates an example block diagram for collecting data during a trial period of a software product, in accordance with aspects of the present disclosure.

In aspects, data may be collected based on monitoring end users 104A-D during a trial period of a software product. For instance, the monitoring may log usage data, telemetry data, and/or satisfaction data. Usage data may include usage time, usage distribution (e.g., during the beginning of the trial, during the end, consistently throughout, etc.), usage time of day (e.g., daytime, nighttime, etc.), percentage of features used (e.g., 34% of product's features), duration per use (e.g., average of 2:34 hours per use), etc. Telemetry data may result from monitoring user and provider systems, product stability, resource stability, network stability, system failures, or the like. Satisfaction data may result from user interactions with the software provider, such as complaints, survey results, support calls, product acquisition, or the like. In addition to data collected during the first trial, the software provider may have collected historical user data or preferences from the particular user or a population of users, such as preferred game genre (e.g., action, shooter, race, puzzle, adventure, simulation, etc.), productivity software package (e.g., commercial enterprise level, personal basic or pro package, etc.), reserved data storage (e.g., personal cloud services, enterprise cloud services), user longevity (e.g., 0-5 years, 5-10 years, etc.), or the like.

FIG. 3 illustrates an example block diagram for evaluating data collected during a trial period to identify patterns, in accordance with aspects of the present disclosure.

For instance, a model may be created based on aggregating and evaluating data from a population of users who engaged in product trials. Patterns may be identified in the data which can be used to generate rules, train a ML model, or as input to any present or future problem-solving technique (e.g., quantum computing, etc.). For example, a pattern may indicate that when usage time is above some amount (e.g., 15 hours), product acquisition results some percentage (e.g., 83%) of the time. That is, usage time may be mapped to product acquisition. In this case, a rule may indicate that, if no product acquisition and usage was less than 15 hours, then more trial time may result in product acquisition. Alternatively, a pattern may indicate testing only during beginning of trial results in product acquisition only 5% of the time. In this case, a usage distribution (e.g., during the first few days only) may be mapped to product acquisition. A corresponding rule may indicate that, if the user only used the product during the first few days of a trial and did not result in product acquisition, then a subsequent trial may not result in product acquisition.

Still further, rather than correlating data directly with an acquisition probability, the data may be evaluated to identify incremental and/or decremental patterns. For example, for each advanced feature or configuration used, there may be an uplift in acquisition rate (e.g., +5% increase); or each time that a product user interface (UI) page loads with a latency over three (3) seconds, there may be a downshift in acquisition rate (e.g., −2% decrease). That is, some signals may have a direct impact on a final acquisition rate, whereas other signals may have incremental or decremental effects on acquisition rate, either linearly or exponentially (e.g., potentially up to some limit on the impact of the signal).

Specific examples illustrating the concepts above may be based on a scenario in which a product is offered with different feature levels. The product may be packaged at a basic consumer level, professional consumer level, and multiple enterprise levels, for instance. While each level may include multiple features, additional features or services may be added at each level. As packages become more robust and/or complex, they may be associated with additional memory and processing resources, configuration overhead, administrative overhead—and cost, for example. Each product level may be associated with a different product code, or stock keeping unit (SKU), for purchase or subscription from the software provider 148.

For example, using the scenario described above, a customer may have selected an incorrect SKU for the trial, which the software provider may recognize based on heuristics regarding the customer (e.g., known preferences, demographics, etc.) and/or product usage before or during the trial. In an aspect, perhaps the consumer activated an enterprise plan including premium features and all of the overhead of managing multiple users (e.g., resource requirements, configuration overhead, administrative overhead, etc.), when all the consumer needed was just more cloud storage space. Telemetry data may indicate that the consumer never used more than one (1) license, assigned more than one (1) seat, or added additional users, but merely used email and cloud storage. In this case, the software provider may offer a follow-up trial with a reduced feature suite, thereby down-selling the consumer toward a more appropriate consumer package for their needs. While the less robust package may result in a lower acquisition return, the return is greater than non-acquisition (e.g., no return) on a higher package.

In another aspect, perhaps a retail customer opts into a frontline enterprise package, which is geared toward mobile or thin devices used by frontline workers for specific tasks (e.g., ordering, registration, etc.) in industries such as restaurants, warehouses, healthcare facilities, or the like. A more traditional enterprise solution may be more appropriate for the retail customer, including business intelligence (BI) tools, an interactive platform for messaging, document management, and conferencing between team members, email, etc. However, the selected frontline plan may include retail specific features such as shifts, inventory, walkie talkie communication, etc., without email, messaging, conferencing, or other productivity-related features. In this case, a more complete package may be provided via a second trial, thereby upselling the customer to a more appropriate solution. As should be appreciated, different product packages may include some feature overlap at different price points. Since an initial trial budget may be associated with an inappropriate product for the customer, course correcting the customer with a second trial of a more appropriate product (even at a lower price point) would be beneficial to the provider. That is, acquisition of a less expensive package is better than no acquisition of a more expensive package. Thus, in such scenarios, the trial budget may be revised accordingly at a provider level rather than at an individual product level to accommodate a subsequent trial period for a different product.

In aspects, as noted above, metrics may be mapped to product acquisition, as shown by the examples in the following table:

TABLE 1

| Metric | Maps to Product Acquisition |
|---|---|
| Feature usage over 45% | 75% of the time |
| Usage under 4 hours | 20% of the time |
| Support call during trial | 27% of the time |
| Product instability during trial | 11% of the time |
| Support outreach during trial | 64% of the time |
| failure during trial | 0% of the time |
| Testing only during beginning of trial | 5% of the time |

In further aspects, as noted above, rules may be determined (or a ML model may be trained) based on correlations between metrics and product acquisition, as shown by any combination of examples in the following table:

TABLE 2

| Condition | Rule |
|---|---|
| If no product acquisition | Then offer second trial period with new |
| and less than 4 | features only within remaining budget, or |
| hours usage | Then offer second trial with new features |
| | plus partial or full set of existing features |
| If no product acquisition | When issue resolved, then offer second |
| and product instability | trial period within remaining budget |
| during trial | |
| If no product acquisition | Then offer partial second trial of unused |
| and less than 45% | features within remaining budget, or |
| feature usage | Then offer new features plus partial or |
| | full set of existing features |
| If no product acquisition | Then initiate support follow-up and offer |
| and support call | second trial within remaining budget, or |
| made | Then offer tutorial experience with |
| | second trial |
| If no product acquisition | Then offer partial second trial of new |
| and preference for | features, or |
| related features of | Then offer second trial with new features |
| different product | plus partial or full set of existing features |

In further examples, the software provider may provide a subscription experience to a suite of different content, e.g., online video games, books, movies, etc. A content “pass” (or subscription) may be offered at different price points, with an increasing selection of content being associated with a higher subscription rate. In an example of a game pass (e.g., a subscription to an online gaming suite), a one-month initial trial subscription may be offered to a user. At the end of the initial trial, the data collected may indicate that the user did not acquire the product and had low game usage, usage time, and/or a combination of both, during the initial trial period. For instance, the user may have been on vacation for a portion of the initial trial period. In this case, based on a correlation between game usage and product acquisition, it may be determined that if game usage is increased, a likelihood of product acquisition may be increased. Based on a trial budget for the game pass and the user's actual game usage, it may be determined that there is a remaining trial budget. Since the total cost to the software provider was below the trial budget for this user, it may be determined that offering a subsequent trial over a subsequent trial period may increase game usage and, consequently, may increase a likelihood of product acquisition. In this case, the software provider may not incur any additional cost over the trial budget, while potentially benefiting from increased likelihood of product acquisition.

In another example of a game pass, a one-month initial trial subscription may be offered to a user. At the end of the initial trial, the telemetry data collected may indicate that the user had high game usage, usage time, and/or a combination of both, during the initial trial period, but did not acquire the product. In this case, based on a correlation between game usage and product acquisition, it may be determined that game usage was sufficient and a likelihood of product acquisition would not be increased by additional trial time. Moreover, based on a trial budget for the game pass and the user's actual game usage, it may be determined that there is not remaining trial budget. In this case, the software provider may not renew the game pass for this user.

In yet another example of a game pass, a one-month initial trial subscription may be offered to a user. At the end of the initial trial, the telemetry data collected may indicate that the user had a poor user experience (UX). For instance, it may be determined that the lack of a nearby datacenter cause unacceptable latency and the user did not acquire the product. In this case, the software provider may not immediately renew the game pass for this user, as a similar outcome would likely result. However, a year later, the game pass may be expanded into new regions. In this case, a new datacenter may be in proximity to this user. The disclosed system may automatically re-evaluate previous users with a sub-par experience and may identify this user as one who would likely have a better user experience a year later. At this time, the trial subscription to the game pass may be extended for a subsequent trial period. In a similar example, the disclosed system may determine that, during an initial product trial, a user was only interested in a particular genre of game, which was not included in the game package at that time, and the user did not acquire the game pass. Later, when the game pass has been upgraded to include the game genre, the game pass may be extended for a subsequent trial period for the user.

In an example of a productivity product suite, an organization may enable an enterprise level five (E5) trial. The E5 trial may be available to some or all users of the organization. Based on the customer data and the usage telemetry, there are a number of potential scenarios. For instance, for one user, sustained, significant usage that began late in the trial period may be observed. If the user did not acquire the product, it may be determined that additional time may be necessary to increase the likelihood of product acquisition. In this case, a subsequent trial may be offered with a trial period based on their actual usage. For instance, if the initial trail started on the first and ended on the last day of the month, and active engagement started on the 25^{th} of the month, the subsequent trial period may be 25 days.

In another example of a productivity suite, the user may have only used the booking and scheduling functionality and did not acquire the product, although the initial trial included a license to other products available in the productivity suite. Based on telemetry data and other analyses, it may be determined that usage of other related, well integrated features of the suite may increase the likelihood of acquiring the who product suite. In this case, a subsequent trial may be offered with access to a subset of the productivity suite, e.g., task and/or task publishing functionality. Based on the partial trial extension, the user may recognize the benefit of additional features which may increase the likelihood of the user acquiring the whole product suite.

In yet another example of a productivity suite, an organization may enable an enterprise level five (E5) trial. While users may trial some products, such as a group platform or an enterprise exchange, the organization may not acquire the product. In aspects, a trial for an enterprise level one (E1), which has subset of products in E5, may be offered for a short period (e.g., 14 days rather than 30 days). In this way, the user may acquire a lower level product including the features the organization was interested in. In this case, telemetry data may indicate sustained usage of the subset of features and product acquisition.

As should be appreciated, the above and other examples are described for purposes of illustration and should not be considered to limit the full scope entitled to the claims.

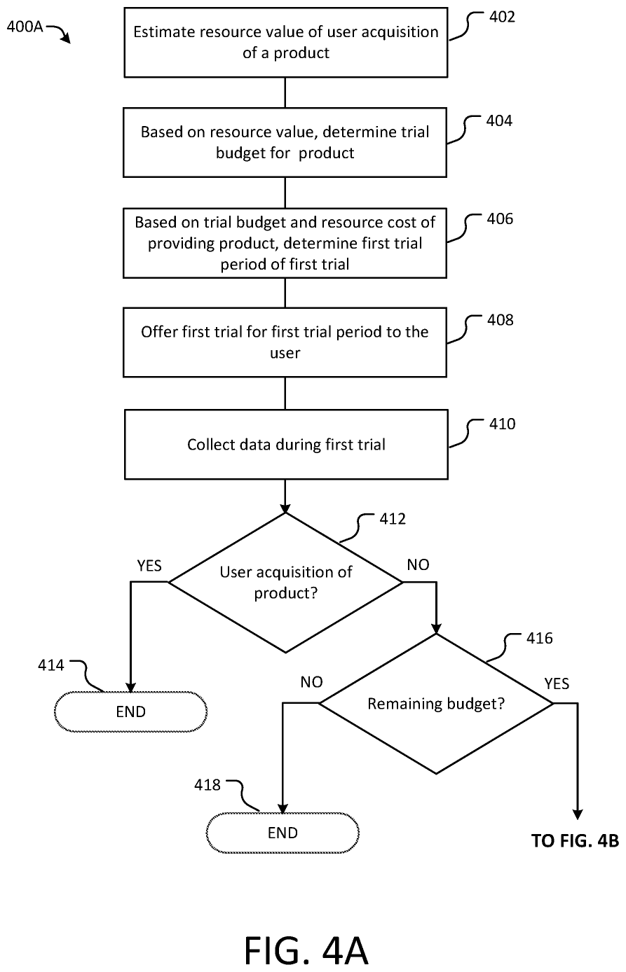

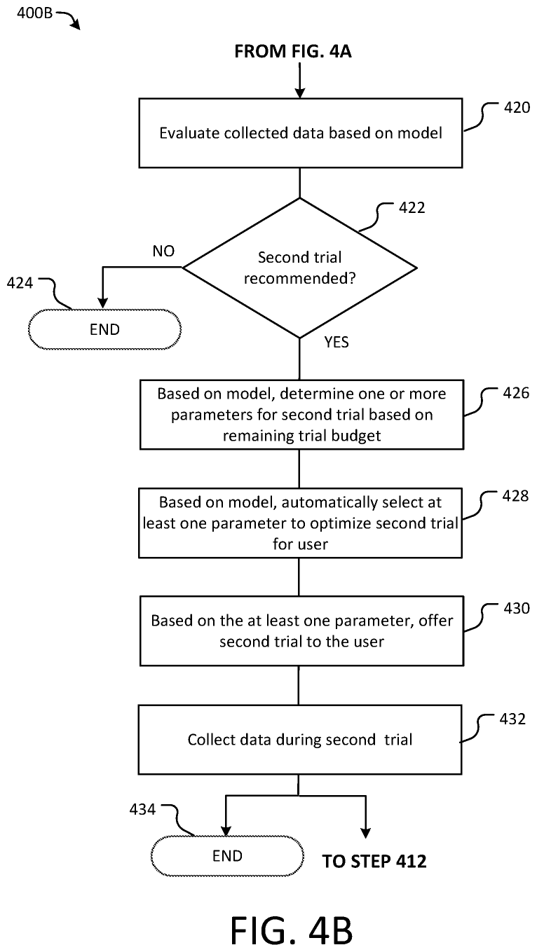

FIGS. 4A-4B illustrate an example method for optimizing a trial of a software product within a budget, in accordance with aspects of the present disclosure.

A general order of the operations for the method 400A is shown in FIGS. 4A-4B. Generally, the method 400A-B may include more or fewer steps or may arrange the order of the steps differently than those shown in FIGS. 4A-4B. The method 400A-B can be executed as a set of computer-executable instructions executed by a computer system and encoded or stored on a computer readable medium. Further, the method 400A-B can be performed by gates or circuits associated with a processor, an ASIC, an FPGA, a SOC or other hardware device. Hereinafter, the method 400A-B shall be explained with reference to the systems, components, devices, modules, software, data structures, data characteristic representations, signaling diagrams, methods, etc., described in conjunction with FIGS. 1-3. For example, aspects of method 400A-B may be performed by a trial optimizer including a trial determiner 110, a trial evaluator 112, and an optimized trial determiner 114 of FIG. 1.

At estimate operation 402, a resource value of a user acquiring a software product (or product) may be determined. The resource value may be based on any number of metrics. For instance, the resource value may be an amount of revenue received from selling (or licensing) the product less an amount of resource cost incurred in developing, testing, maintaining, and supporting the product, for instance. In addition to software development costs, a software provider may incur resources costs for hosting the product, including energy resources, processing resources, network resources, memory and storage resources, real estate, labor resources, and the like. In aspects, these resource costs may be aggregated for a time period (e.g., 1 minute, 1 hour, 1 day, etc.). The resource costs per user may then be determined by, for example, taking the aggregated resource costs for the time period divided by the average number of users utilizing the product during the same period. As should be appreciated, a resource value and/or resource costs of the product may be determined in any suitable way based on any suitable metrics.

At determine operation 404, based on the resource value, a trial budget for testing the product may be determined. For instance, the trial budget may be some portion or percentage of the resource value that the provider is willing to incur to promote the product. For instance, the trial budget may be 5%, 10%, 25%, or other percentage, of the resource value of the product. Alternatively, rather than being a portion of the resource value, the trial budget may be equal to or greater than the resource value, e.g., when a critical mass of users is needed for product success.

At determine operation 406, based on the trial budget and the resource costs per user per time period, a first trial period may be determined for a first trial of the product. In aspects, the first trial period is an amount of time a user can test the product within the trial budget based on the resource costs per user. That is, if the resource costs per user are $5.00 per day, and the trial budget is $50.00, the first trial period for the user may be 10 days.

At offer operation 408, the first trial may be offered to the user for the first trial period. In aspects, the user may receive the offer from the software provider via any suitable means. For example, the offer may be emailed to the user, may be provided in a popup or ribbon displayed in another application accessed by the user, may be texted to the user, or otherwise. In response to receiving the offer, the user may activate the first trial to test the product. In some aspects, the first trial period may begin when the user activates the first trial. During the first trial, the user may access and use various features of the product. When the first trial period ends, the user will no longer have access to the product—unless the user acquires the product.

At collect operation 410, data may be collected based on monitoring the first trial. For instance, the monitoring may log usage data, telemetry data, and/or satisfaction data. Usage data may include usage time, usage distribution (e.g., during the beginning of the trial, during the end, consistently throughout, etc.), usage time of day (e.g., daytime, nighttime, etc.), percentage of features used (e.g., 34% of product's features), duration per use (e.g., average of 2:34 hours per use), etc. Telemetry data may result from monitoring user and provider systems, product stability, resource stability, network stability, system failures, or the like. Satisfaction data may result from user interactions with the software provider, such as complaints, survey results, support calls, product acquisition, or the like. In addition to data collected during the first trial, the software provider may have collected historical user data or preferences from the particular user or a population of users, such as preferred game genre (e.g., action, shooter, race, puzzle, adventure, simulation, etc.), productivity software package (e.g., commercial enterprise level, personal basic or pro package, etc.), reserved data storage (e.g., personal cloud services, enterprise cloud services), user longevity (e.g., 0-5 years, 5-10 years, etc.), or the like.

At decision operation 412, it may be determined whether the user acquired the product in response to the first trial. If the user acquired the product, the method may progress to end operation 414. If the user did not acquire the product, the method may progress to decision operation 416.

At decision operation 416, when the user did not acquire the product, it may be determined whether there is a remainder of the trial budget. As noted above, the trial budget may be some portion or percentage of the resource value that the provider is willing to incur to promote the product. As noted above, the software provider may collect various usage data during the trial. Based on the usage data and the known resource costs per user, the software provider may determine an actual resource cost of the user's usage during the first trial. For instance, using the example above, if the resource costs per user per day are $5.00 and the usage during the first trial was 4.3 days, the actual resource cost of the user's usage would be $21.50. Again, based on the above trial budget of $50.00, the remaining trial budget would be $28.50. If there is not a remaining trial budget, the method may progress to end operation 418. If there is a remaining trial budget, the method may progress to evaluate operation 420 of FIG. 4B.

At evaluation operation 420, the collected data may be evaluated based on a model. In aspects, the model may be a rule-based model, a machine learning (ML) based model, or any other suitable model for evaluating data. For instance, as described with respect to FIG. 3, the model may be created based on evaluating data from a population of users who have engaged in product trials. Patterns may be identified in the data which can be used to generate rules and/or train a ML model. In aspects, a pattern may indicate that when usage time is above some amount (e.g., 15 hours), the user acquires the product some percentage (e.g., 83%) of the time. In this case, a rule may indicate that, if the user did not acquire the product and usage was less than 15 hours, then more time to test the product may result in product acquisition. Alternatively, a pattern may indicate that when a user only tests the product during the first few days of a trial, the user acquires the product 5% of the time. In this case, a rule may indicate that, if the user only used the product during the first few days of a trial and did not acquire the product, then a second trial may not result in product acquisition.

At decision operation 422, it may be determined whether a second trial is recommended. For instance, based on the first example above, when additional usage time may result in product acquisition, a second trial may be recommended. Alternatively, based on the second example above, when additional testing is not likely to result in product acquisition, a second trial may not be recommended. If a second trial is not recommended, the method may progress to end operation 424. If a second trial is recommended, the method may progress to determination operation 426.

At determination operation 426, based on the model and the remaining trial budget, one or more parameters for a second trial may be determined. The one or more parameters may include, for instance, a second trial period, a second trial amount of uses, a portion of the day, a subset of the product, a setup experience, or a support experience. In some cases, the parameters may be based on a rule or learning. For instance, if the rule indicates that an increase in feature usage may result in product acquisition, a corresponding parameter may indicate a subset of the product (e.g., unused features) for the second trial. In other cases, the parameters may be based on collected data specific to the user. As an example, if the user only tested the product in the evenings, the parameter may specify a time of day for offering the second trial (e.g., between 5:00 PM and midnight). These rules may be limited, however, such that the second trial does not exceed the remaining trial budget. That is, for a remaining trial budget of $28.50 and resource costs per user per day of $5.00 (or $0.21 per hour), the user may be offered a second trial with a second trial period of 5.7 days (e.g., rounded to 6 days). However, if the second trial is only offered from 5:00 PM to midnight (e.g., 7 hours per day) based on a user preference, the second trial period may be 135.7 hours, or 19.4 days (e.g., rounded to 19 days) from 5:00 PM to midnight.

At automatic selection operation 428, at least one of the one or more parameters may be selected to optimize the second trial for the user. As detailed above, the one or more parameters may result from various rules or training applied to the collected data. However, some parameters may be more likely to result in product acquisition within the remaining trial budget than others. For instance, based on evaluating the collected data with the model, it may be determined that offering a subset of unused features for a shorter trial period may be more likely to result in product acquisition than offering the full product for a longer trial period. In this case, the model may automatically select the at least one parameter directed to the subset of unused features to optimize the second trial for the user. That is, the model may automatically select the at least one parameter that is most likely to result in product acquisition by this particular user. In this way, the second trial is not only optimized for product acquisition, the optimized trial is customized for a particular user.

At offer operation 430, the second trial may be offered to the user based on the at least one parameter (e.g., subset of features, second trial period, time of day, etc.). In aspects, the user may receive the offer from the software provider via any suitable means, as described above. As with the first trial, the second trial may begin when the user activates the second trial. During the second trial, the user may access and use the product based on the at least one parameter. When the second trial ends, the user will no longer have access to the product—unless the user acquires the product.

At collect operation 432, data may be collected based on monitoring the second trial. As detailed above, the monitoring may log usage data, telemetry data, and/or satisfaction data. Additionally, historical data from previous trials or user preferences may be stored. In aspects, the data collected with respect to the second trial may be used to further inform the model or, when the second trial did not result in product acquisition, may be used to determine whether a third trial is recommended. The method may return to decision operation 412 for further consideration of subsequent trials. Alternatively, the method may end at end operation 434.

As should be appreciated, the operations 402-434 are described for purposes of illustrating the present methods and systems and are not intended to limit the disclosure to a particular sequence of steps. That is, steps may be performed in different order, additional steps may be performed, and disclosed steps may be excluded without departing from the present disclosure.

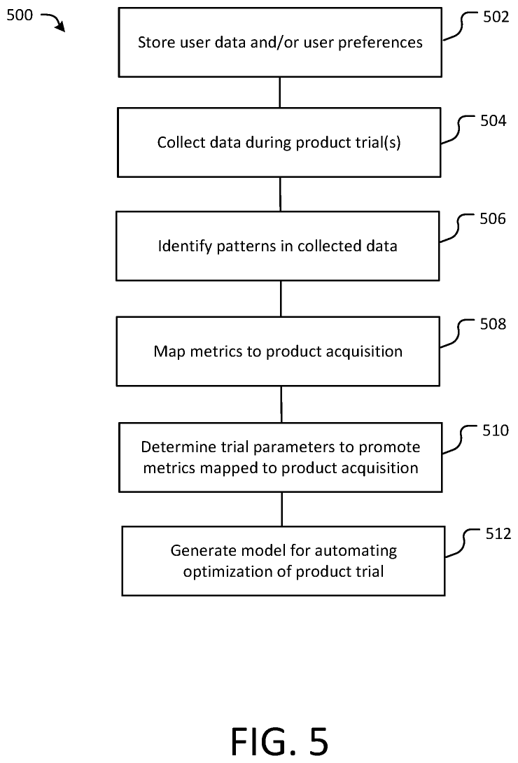

FIG. 5 illustrates an example method for determining rules or training a ML model based on patterns in collected data, in accordance with aspects of the present disclosure.

A general order of the operations for the method 500 is shown in FIG. 5. Generally, the method 500 may include more or fewer steps or may arrange the order of the steps differently than those shown in FIG. 5. The method 500 can be executed as a set of computer-executable instructions executed by a computer system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with FIGS. 1-3. For example, aspects of method 400A-B may be performed by a trial optimizer including a trial determiner 110, a trial evaluator 112, and an optimized trial determiner 114 of FIG. 1.

At store operation 502, user data and/or preferences may be stored for a population of users by a software provider. User preferences may include, for example, preferred game genre (e.g., action, shooter, race, puzzle, adventure, simulation, etc.), type of productivity software package (e.g., commercial enterprise level, personal basic or pro package, etc.), level of reserved data storage (e.g., personal cloud services, enterprise cloud services), user longevity (e.g., 0-5 years, 5-10 years, etc.), or the like. Additionally, tenant-level metadata and/or preferences may be stored. For example, a tenant may provide optional information such as declaring that they are an education institution, a retail service provider, a fashion house, an airline provider, or the like.

At collect operation 504, data may be collected during a product trials participated in by a population of users. Collected data, for instance, may include usage data, telemetry data, satisfaction data, and the like. As detailed above, usage data may include usage time, usage distribution (e.g., during the beginning of the trial, during the end, consistently throughout, etc.), usage time of day (e.g., daytime, nighttime, etc.), percentage of features used (e.g., 34% of product's features), duration per use (e.g., average of 2:34 hours per use), etc. Telemetry data may result from monitoring user and provider systems, product stability, resource stability, network stability, system failures, or the like. Satisfaction data may result from user interactions with the software provider, such as complaints, survey results, support calls, product acquisition, or the like.

At identify operation 506, patterns in the stored data and/or the collected data may be identified. In aspects, a pattern may involve a particular metric correlated with a particular result. For example, a pattern may indicate that when usage time is above some amount (e.g., 15 hours), the user acquires the product some percentage (e.g., 83%) of the time. In this case, a rule may indicate that, if the user did not acquire the product and usage was less than 15 hours, then more time to test the product may result in product acquisition. Alternatively, a pattern may indicate that when a user only tests the product during the first few days of a trial, the user acquires the product 5% of the time. In this case, a rule may indicate that, if the user only used the product during the first few days of a trial and did not acquire the product, then a second trial may not result in product acquisition.

At map operation 508, metrics associated with patterns may be mapped to product acquisition. For example, a pattern may indicate that when usage time is above some amount (e.g., 15 hours), product acquisition occurs some percentage (e.g., 83%) of the time. In this case, usage time may be mapped to product acquisition. Alternatively, a pattern may indicate that when an end user only tests the product during the first few days of a trial, product acquisition occurs only 5% of the time. In this case, a usage distribution (e.g., during the first few days only) may be mapped to product acquisition.

At determine operation 510, one or more trial parameters may be determined that promote metrics mapped to product acquisition (e.g., additional trial time to raise usage data, targeted feature offering to increase overall feature usage). The one or more trial parameters may include, for instance, a subsequent trial period, a subsequent trial amount of uses, a portion of the day, a subset of the product, a setup experience, or a support experience. In an example, if feature usage is mapped to product acquisition, increased feature usage may increase a likelihood of product acquisition. In this case, a corresponding trial parameter may indicate a subset of the product (e.g., unused features) to offer in the subsequent trial. The targeted offering of unused features may increase overall feature usage, which may increase a likelihood of product acquisition. Similarly, the one or more trial parameters may be determined based on collected data specific to the user. As an example, if the user only tested the product in the evenings during the initial trial, a corresponding trial parameter may specify a time of day for offering the subsequent trial (e.g., between 5:00 PM and midnight). In this case, making the product available during a preferred time of the day may increase overall usage, which may increase a likelihood of product acquisition.

At generate operation 512, a model may be generated for automating optimization of a subsequent product trial. For instance, a rule-based model may be designed to recognize a condition associated with a metric correlated with the product acquisition and output at least one parameter for promoting the metric to increase a likelihood of the product acquisition. For instance, the rule-based model may be designed to recognize that, if usage was less than 15 hours and the user did not acquire the product, then an increase in trial time (promoting a corresponding increase in usage) may result in product acquisition. Alternatively, the rule-based model may be designed to recognize that, if the user only used the product during the first few days of a trial and did not acquire the product, then a subsequent trial may be unlikely to result in product acquisition. Similarly, a ML model may be trained to recognize a metric correlated with a product acquisition and to determine at least one parameter for promoting the metric to increase a likelihood of the product acquisition. For instance, the ML model may be trained to recognize a correlation between high usage data and product acquisition. Based on the detected metric correlation, the ML model may be further trained to determine at least one parameter for promoting the metric to increase a likelihood of the product acquisition (e.g., additional trial time to raise usage time).

As should be appreciated, the model may be conditioned to identify one or more trial parameters that promote product acquisition without exceeding the remaining trial budget. That is, for a remaining trial budget of $28.50 and resource costs per user of $5.00 per day (or $0.21 per hour), the model may determine a subsequent trial period of 5.7 days (e.g., rounded to 6 days) to increase usage time. However, if the subsequent trial is only offered from 5:00 PM to midnight (e.g., 7 hours per day) based on a user preference for nighttime use, the subsequent trial period may be 135.7 hours, or 19.4 days (e.g., rounded to 19 days) from 5:00 PM to midnight. In this way, the subsequent trial is offered during a preferred time of day for a longer period, which may further increase usage time and the likelihood of product acquisition.

As should be further appreciated, the model may be designed to select at least one parameter for optimizing a second trail for a particular user. For example, the ML model may determine a plurality of parameters with varying likelihoods of resulting in product acquisition. The subsequent trial may be optimized by automatically selecting the at least one parameter determined to have the highest likelihood of resulting in product acquisition by the particular user within the remaining trial budget. For instance, referring to the example above, the model may determine that the subsequent trial may be optimized for the particular user by targeting a preferred time of day for product access.

As should be appreciated, the operations 502-512 are described for purposes of illustrating the present methods and systems and are not intended to limit the disclosure to a particular sequence of steps. That is, steps may be performed in different order, additional steps may be performed, and disclosed steps may be excluded without departing from the present disclosure.

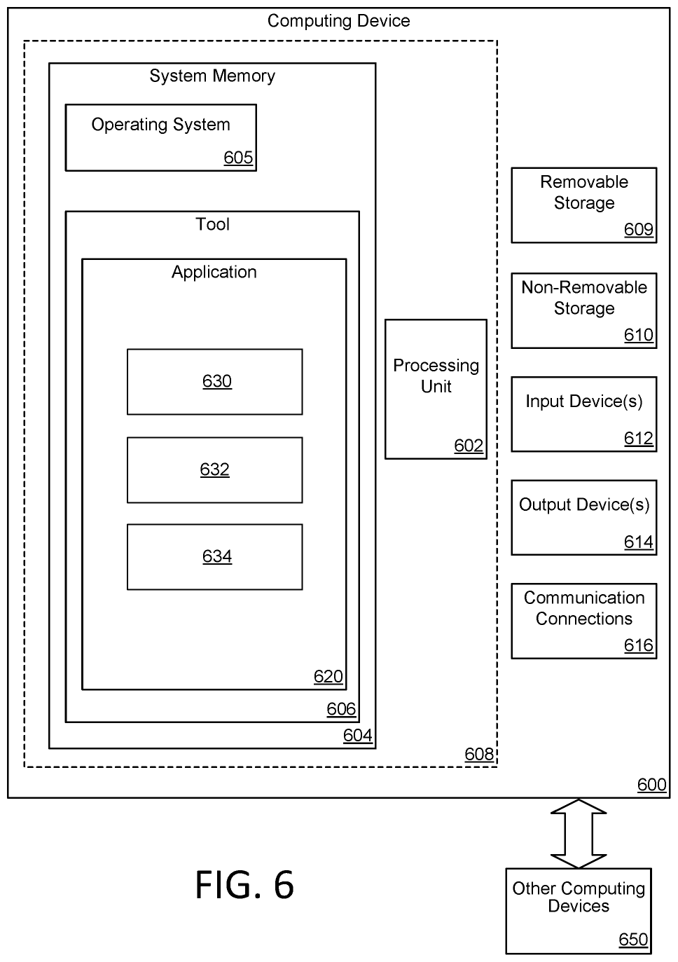

FIG. 6 is a block diagram illustrating physical components (e.g., hardware) of a computing device 600 with which aspects of the disclosure may be practiced. The computing device components described below may have computer executable instructions for implementing an automated system 620 for optimizing a trial of a software product within a budget, including computer executable instructions for implementing the automated system 620 that can be executed to implement the methods disclosed herein. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program tools 606 suitable for implementing the automated system 620, such as one or more components with regard to FIG. 1 and, in particular, initial trial determiner 630, initial trial evaluator 632, and subsequent trial optimizer 634.

The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program tools 606 (e.g., message controller 620) may perform processes including, but not limited to, the aspects, as described herein. Other program tools that may be used in accordance with aspects of the present disclosure, and in particular for automatically optimizing a trial of a software product within a budget, which may include initial trial determiner 630, initial trial evaluator 632, and subsequent trial optimizer 634.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

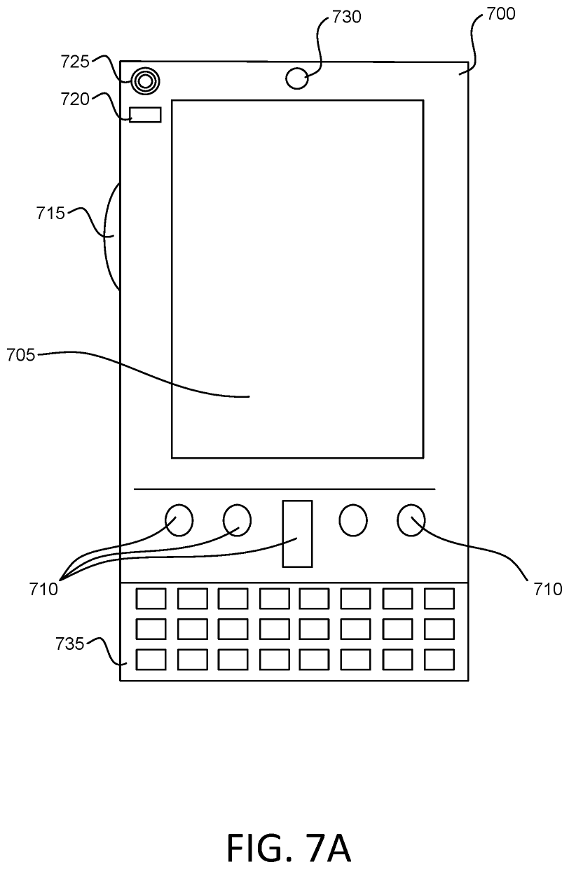

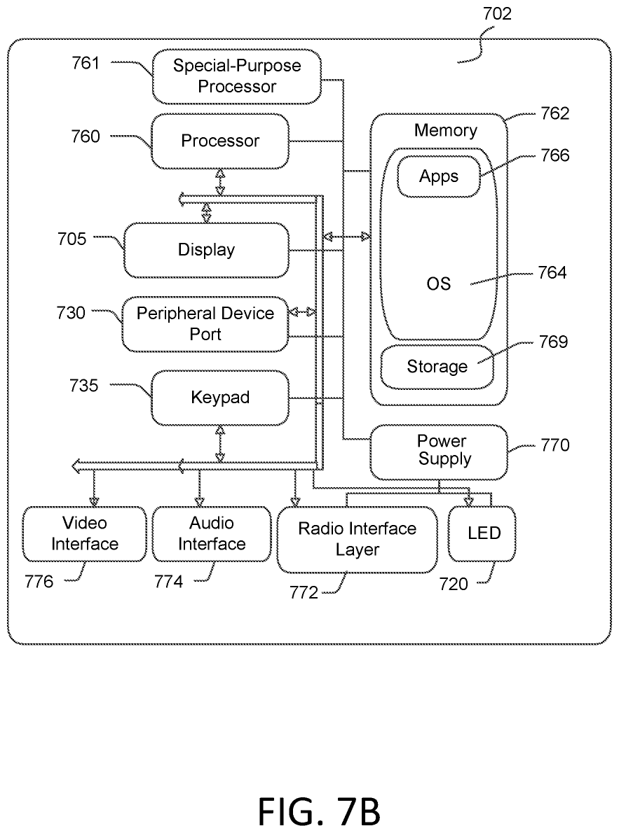

FIGS. 7A and 7B illustrate a computing device or mobile computing device 700, for example, a mobile telephone, a smart phone, wearable computer (such as a smart watch), a tablet computer, a laptop computer, and the like, with which aspects of the disclosure may be practiced. In some aspects, the computing device used by a user (e.g., end user 104 as shown in the system 100 in FIG. 1) may be a mobile computing device.

With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included as an optional input element, a side input element 715 allows further user input. The side input element 715 may be a rotary switch, a button, or any other type of manual input element. In alternative aspects, mobile computing device 700 may incorporate more or less input elements. For example, the display 705 may not be a touch screen in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of computing device, a server (e.g., server farm 146 as shown in FIG. 1), a mobile computing device, etc. That is, the mobile computing device 700 can incorporate a system 702 (e.g., a system architecture) to implement some aspects. The system 702 can implemented as a “smart phone” capable of running one or more applications (e.g., browser, e-mail, calendaring, contact managers, messaging clients, games, and media clients/players). In some aspects, the system 702 is integrated as a computing device, such as an integrated digital assistant (PDA) and wireless phone.

One or more application programs 766 may be loaded into the memory 762 and run on or in association with the operating system 764. Examples of the application programs include phone dialer programs, e-mail programs, information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 868 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 (e.g., LED) may be used to provide visual notifications, and/or an audio interface 774 may be used for producing audible notifications via the audio transducer 725. In the illustrated configuration, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of devices connected to a peripheral device port 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to systems and methods for optimizing a trial of a software product within a budget, according to at least the examples provided in the sections below. The system comprises at least one processor; and memory storing instructions that, when executed by the at least one processor, cause the system to perform operations. The operation comprises estimating a resource value of product acquisition for a product; based on the estimated resource value, determining a trial budget for the product; based on the trial budget and a resource cost of providing the product, determining a first trial period for a first trial of the product; offering the first trial of the product to the user for the first trial period; collecting data associated with the first trial of the product; in response to the first trial not resulting in the product acquisition, determining a remaining trial budget based on the resource cost and the collected data; based on evaluating the collected data using a model, determining at least one parameter for optimizing a second trial of the product for the user within the remaining trial budget; and based on the at least one parameter, offering the second trial of the product to the user. The resource cost of providing the product is based on a usage time or a usage amount. The resource cost of providing the product is determined on a per-user basis over time. The collected data includes one or more of: telemetry data, usage time, usage amount, usage consistency, user satisfaction data, or a user experience (UX) level. The UX level during the first trial is based on one or more of: product instability, network latency, processing latency, user-reported issues, helpline usage, or complaints. The model is one of a rule-based model or a machine learning (ML) model. Optimizing the second trial of the product for the user is automated. Optimizing the second trial of the product for the user includes selecting the at least one parameter with the highest likelihood of resulting in product acquisition. The at least one parameter comprises one or more of: a second trial period, a second trial amount of uses, a portion of the day, a subset of the product, a setup experience, or a support experience.

Another aspect of the technology relates to a method of generating a model to optimize a product trial for a user. The method comprises collecting data associated with a plurality of product trials; identifying patterns in the collected data; based on the patterns, mapping one or more metrics to a product acquisition; determining one or more trial parameters for promoting metrics mapped to the product acquisition; and generating a model for automatically optimizing a product trial for a user, wherein the model is designed to optimized the product trial for the user by automatically selecting at least one trial parameter having a highest likelihood of product acquisition by the user within a trial budget for the product. The model is a rule-based model. The rule-based model is designed to recognize a condition associated with a metric correlated with the product acquisition and output at least one parameter for promoting the metric to increase a likelihood of the product acquisition. The model is a machine-learning (ML) model. The ML model is trained to recognize a metric correlated with the product acquisition and to determine at least one parameter for promoting the metric to increase a likelihood of the product acquisition.

In still further aspects, the technology relates to a method of optimizing a product trial for a user within a trial budget. The method comprises estimating a resource value of product acquisition for a product; based on the estimated resource value, determining the trial budget for the product; based on the trial budget and a resource cost of providing the product, determining a first trial period for a first trial of the product; offering the first trial of the product to the user for the first trial period; collecting data associated with the first trial of the product; in response to the first trial not resulting in the product acquisition, determining a remaining trial budget based on the resource cost and the collected data; based on evaluating the collected data using a model, determining at least one parameter for optimizing a second trial of the product for the user within the remaining trial budget; and based on the at least one parameter, offering the second trial of the product to the user. The resource cost of providing the product is based on a usage time or a usage amount. The resource cost of providing the product is determined on a per-user basis over time. The collected data includes one or more of: telemetry data, usage time, usage amount, usage consistency, user satisfaction data, or a user experience (UX) level. The UX level during the first trial is based on one or more of: product instability, network latency, processing latency, user-reported issues, helpline usage, or complaints. The at least one parameter comprises one or more of: a second trial period, a second trial amount of uses, a portion of the day, a subset of the product, a setup experience, or a support experience.

Any of the one or more above aspects in combination with any other of the one or more aspect. Any of the one or more aspects as described herein.

1. A system, comprising:
at least one processor; and
memory storing instructions that, when executed by the at least one processor, cause the system to perform operations, comprising:
estimating a resource value of product acquisition for a product;
based on the estimated resource value, determining a trial budget for the product;
based on the trial budget and a resource cost of providing the product, determining a first trial period for a first trial of the product;
offering the first trial of the product to the user for the first trial period;
collecting data associated with the first trial of the product;
in response to the first trial not resulting in the product acquisition, determining a remaining trial budget based on the resource cost and the collected data;
based on evaluating the collected data using a model, determining at least one parameter for optimizing a second trial of the product for the user within the remaining trial budget; and
based on the at least one parameter, offering the second trial of the product to the user.

2. The system of claim 1, wherein the resource cost of providing the product is based on a usage time or a usage amount.

3. The system of claim 1, wherein the resource cost of providing the product is determined on a per-user basis over time.

4. The system of claim 1, wherein the collected data includes one or more of: telemetry data, usage time, usage amount, usage consistency, user satisfaction data, or a user experience (UX) level.

5. The system of claim 4, wherein the UX level during the first trial is based on one or more of: product instability, network latency, processing latency, user-reported issues, helpline usage, or complaints.

6. The system of claim 1, wherein the model is one of a rule-based model or a machine learning (ML) model.

7. The system of claim 1, wherein optimizing the second trial of the product for the user is automated.

8. The system of claim 1, wherein optimizing the second trial of the product for the user includes selecting the at least one parameter with the highest likelihood of resulting in product acquisition.

9. The system of claim 8, wherein the at least one parameter comprises one or more of: a second trial period, a second trial amount of uses, a portion of the day, a subset of the product, a setup experience, or a support experience.

10. A method of generating a model to optimize a product trial for a user, comprising:
collecting data associated with a plurality of product trials;
identifying patterns in the collected data;
based on the patterns, mapping one or more metrics to a product acquisition;
determining one or more trial parameters for promoting metrics mapped to the product acquisition; and
generating a model for automatically optimizing a product trial for a user, wherein the model is designed to optimized the product trial for the user by automatically selecting at least one trial parameter having a highest likelihood of product acquisition by the user within a trial budget for the product.

11. The method of claim 10, wherein the model is a rule-based model.

12. The method of claim 11, wherein the rule-based model is designed to recognize a condition associated with a metric correlated with the product acquisition and output at least one parameter for promoting the metric to increase a likelihood of the product acquisition.

13. The method of claim 10, wherein the model is a machine-learning (ML) model.

14. The method of claim 13, wherein the ML model is trained to recognize a metric correlated with the product acquisition and to determine at least one parameter for promoting the metric to increase a likelihood of the product acquisition.

15. A method of optimizing a product trial for a user within a trial budget, comprising:
estimating a resource value of product acquisition for a product;
based on the estimated resource value, determining the trial budget for the product;
based on the trial budget and a resource cost of providing the product, determining a first trial period for a first trial of the product;
offering the first trial of the product to the user for the first trial period;
collecting data associated with the first trial of the product;
in response to the first trial not resulting in the product acquisition, determining a remaining trial budget based on the resource cost and the collected data;
based on evaluating the collected data using a model, determining at least one parameter for optimizing a second trial of the product for the user within the remaining trial budget; and
based on the at least one parameter, offering the second trial of the product to the user.

16. The method of claim 15, wherein the resource cost of providing the product is based on a usage time or a usage amount.

17. The method of claim 15, wherein the resource cost of providing the product is determined on a per-user basis over time.

18. The method of claim 15, wherein the collected data includes one or more of: telemetry data, usage time, usage amount, usage consistency, user satisfaction data, or a user experience (UX) level.

19. The method of claim 18, wherein the UX level during the first trial is based on one or more of: product instability, network latency, processing latency, user-reported issues, helpline usage, or complaints.

20. The method of claim 15, wherein the at least one parameter comprises one or more of: a second trial period, a second trial amount of uses, a portion of the day, a subset of the product, a setup experience, or a support experience.
